(19) United States
(12) Patent Application Publication
(10) Pub. No.: US 2022/0234171 A1
(43) Pub. Date: Jul. 28, 2022

(54) FISH FILLET KNIFE SHEATH WITH THE SHARPENING FUNCTION

(71) Applicant: Zhenguo PAN, Shandong (CN)

(72) Inventor: Zhenguo PAN, Shandong (CN)

(21) Appl. No.: 17/160,379

(22) Filed: Jan. 28, 2021

(51) Int. Cl. B24D 15/08; B26B 3/00; B26B 29/02

(52) U.S. Cl. CPC B24D 15/084; B26B 29/02; B26B 3/00

(57) ABSTRACT

This invention is about a fish fillet knife sheath with sharpening function, inside the sheath body features a storage chute, inside the storage chute features a sliding in sharpening rod, a pop-up pressure spring located between the front end of the storage chute and the sharpening rod, in the rear of the sheath body features a locking lever with a hinge, the rear part of the locking lever features a locking block which extrudes towards the sharpening rod, the front lateral side of the locking block features a locking slope oblique towards the sharpening rod from the front to the back; the rear part of the sharpening rod features a compaction slope which is coordinated with the locking slope, the sheath body features a cam switch via the switch pin with a hinge, the cam switch features a locking pressure spring. This invention is simple, convenient, beautiful and hands protective.

### BACKGROUND OF THE INVENTION

This invention relates to the outdoor supplies field, particularly to a fish fillet knife sheath which has the sharpening function is characterized by a simple structure, convenient use and neat and beautiful appearance.

Along with the social advancement, people's life quality has been improved rapidly, and outdoor sports have become a part of high-quality life of urban white-collar workers gradually. Among various outdoor sports, fishing is very popular, because fishermen can have an intimate contact with the nature.

Fishermen are fond of fishing, so they will spend a long time on fishing every time. In this process, some fishermen like make fresh fish into sashimi to replenish their strength. When there are many big fish, some fishermen also use the fish fillet knife to cut off high-quality meat and discard fish bone and viscera. The fish fillet knife which can be used for making sashimi or filleting fish is a portable fishing tool. When making sashimi, fish in different position of fish body needs to be cut off precisely, so the fish fillet knife should be very sharp, and usually the knife needs to be sharpened for several times with a piece of knife stone or a sharpening rod before use. Existing fish fillet knifes need a separate piece of knife stone or sharpening rod. Large knife stone or sharpening rod is heavy and difficult to carry, while small knife stone or sharpening rod is not easy to carry or fix, it is not easy to operate, and it is easy to hurt hands.

### BRIEF SUMMARY OF THE INVENTION

The present invention is to solve deficiencies of existing technologies, provide a fish fillet knife sheath which has the sharpening function and is characterized by a simple structure, convenient use, neat and beautiful appearance and is not easy to hurt hands.

The technical solution of the present invention to the aforesaid existing technical problems is:

A fish fillet knife sheath with the sharpening function and provided with a sheath body, characterized in that the sheath body inside is provided with a storage chute, the storage chute inside is provided with a sharpening rod which can slide in the axial direction, there is a pop-up pressure spring between the front end of the storage chute and the front end of the sharpening rod, the sheath body on the side of the storage chute in the rear of the sheath body is provided with a locking lever with a hinge, the rear part of the locking lever is provided with a locking block which extrudes towards the sharpening rod, the front lateral side of the locking block is provided with a locking slope oblique towards the sharpening rod from the front to the back; the rear part of the sharpening rod is provided with a compaction slope which is coordinated with the locking slope, the sheath body is provided with a cam switch via the switch pin with a hinge and the cam switch is provided with a locking pressure spring. When the sharpening rod is totally pressed into the storage chute, the locking pressure spring presses the cam switch to make the cam switch rotates, until the bump of the cam switch leans on the locking lever, the locking slope on the front lateral side of the locking block closely leans on the compaction slope on the rear part of the sharpening rod to lock the sharpening rod inside the storage chute in the axial direction; when the sharpening rod is needed, the cam switch can be operated, until its bump separates from the locking lever, under the action of elasticity of the pop-up pressure spring, the sharpening rod slides backward, the locking lever rotates under the action of the compaction slope and the locking slope, the locking block separates from the rear part of the sharpening rod, and the sharpening rod pops up backward. This structure is simple and easy to use, and the cost is low.

The said storage chute of the present invention is provided on the upper part of the sheath body, said locking lever (with a rectangular cross section) is a straight lever provided above the sharpening rod; the structure of the said cam switch is as follows: the sheath body above the locking lever is provided with a wheel under which there is a pressure bump, there is a pressure plane which can closely lean on the upper side of the locking lever above the pressure bump, there is a switch handle above the wheel, said locking pressure spring is provided between the rear part of the wheel or the pressure bump on the rear part of the wheel and the sheath body above the wheel or over the rear of the wheel. In such a case, the sharpening rod is inside the storage chute, the locking slope on the front lateral side of the locking block closely leans on the compaction slope on the rear part of the sharpening rod to lock the sharpening rod inside the storage chute in an axial direction.

The said locking lever in the present invention is a straight lever with a rectangular cross section.

In the present invention, the said storage chute inside is provided with a connection fixing sleeve which can only slide inside the said storage chute, the front end of the sharpening rod is installed inside the connection fixing sleeve, and the rear part of the pop-up pressure spring connects to the front end of the connection fixing sleeve in a fixed way. The sharpening rod fits the clearance of the storage chute, the contact surface between the connection fixing sleeve and the storage chute is small, and the slide resistance is small, so slide can be smoother.

The rear part of the said sheath body in the present invention is provided with a sharpener, the rear part of the sheath body of the said sharpener 9 is provided with a V-shaped mounting slot, and the mounting slot inside is installed with two pieces of knife stone provided in the shape of V. After the fish fillet knife is not used for a long time and is relatively blunt, the knife can be quickly sharpened with the sharpener roughly and then can be sharpened with the sharpening rod finely.

When using the present invention, the operator should draw the fish fillet knife out from the sheath, operate the locking switch and release the sharpening rod. Under the action of the pop-up pressure spring, the rear part of the sharpening rod pops up from the sheath body. The front part of the sharpening rod is inside the sheath body. By holding the sheath body with one hand and holding the fish fillet knife with the other hand, the fish fillet knife can be sharpened finely with the sharpening rod. After sharpening is finished, the operator should push the sharpening rod into the storage chute and draw the locking switch to lock the sharpening rod. The present invention is characterized by a simple structure, convenient use and neat and beautiful appearance and is not easy to hurt hands.

### BRIEF DESCRIPTION OF THE DRAWINGS

FIG. 1 is the schematic diagram showing the structure of the present invention.

FIG. 2 is the schematic diagram showing the structure of the present invention when the sharpening rod pops up from the storage chute of the sheath body.

FIG. 3 is a partial enlarged diagram of part A in FIG. 2.

### DETAILED DESCRIPTION OF THE INVENTION

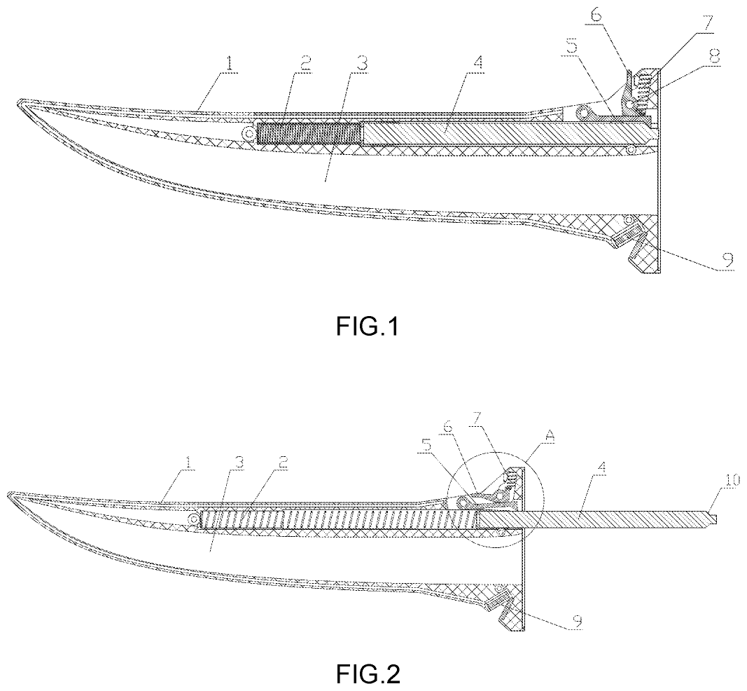

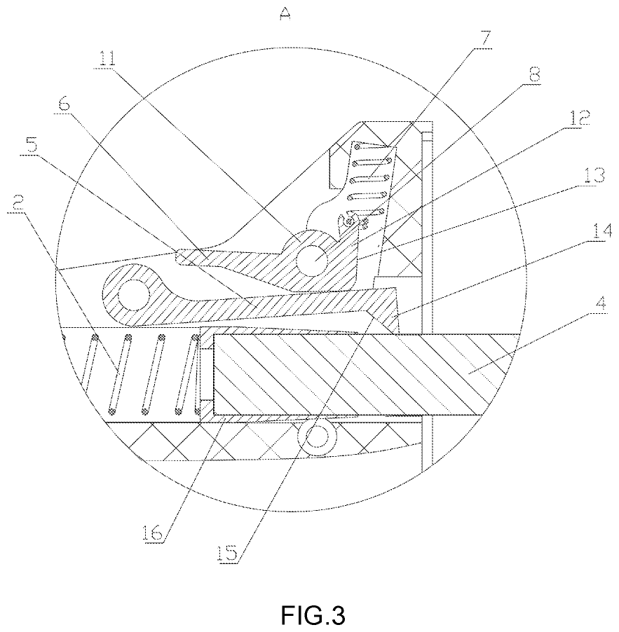

The present invention is a fish fillet knife sheath with the sharpening function and is provided with a sheath body 1, the sheath mouth of the sheath body 1 is on the rear part of the sheath body, and the fish fillet knife is inserted into the chute 3 inside the sheath body from the sheath mouth. The upper part of the sheath body 1 is longitudinally provided with a cylindrical storage chute with an open mouth on the rear part. FIG. 1 and FIG. 2 show that the storage chute is just above the chute 3. The storage chute inside is provided with a cylindrical sharpening rod 4 which can slide in the axial direction, there is a pop-up pressure spring 2 between the front end of the storage chute and the front end of the sharpening rod, the rear part of the sheath body 1 above the storage chute connects to a locking lever 5 with a hinge, the locking lever 5 is a straight lever with a rectangular cross section, the rear part of the locking lever 5 is provided with a locking block 14 which extrudes downward, and the front lateral side of the locking block 14 is provided with a locking slope 15 which is oblique downward from the front to the back; the rear part of the sharpening rod 4 is provided with a compaction slope 10 which fits the locking slope 15 and oblique downward from the front to the back, and the compaction slope 15 can closely lean on the compaction slope 10. The sheath body 1 on the rear upper side of the locking lever 5 is provided with a cam switch via the switch pin with a hinge and the cam switch is provided with a locking pressure spring 7. the structure of the said cam switch is as follows: the sheath body 1 above the locking lever 5 is provided with a wheel 11 via the switch pin 8, there is a pressure bump 12 under the wheel 11, there is a pressure plane 13 which can closely lean on the upper side of the locking lever 5 on the lower lateral side of the pressure bump 12, there is a switch handle 6 on the upper side of the wheel 11, the switch handle can drive the wheel 11 when it is operated and is prominent on the sheath body 1, and said locking pressure spring 7 is provided between the pressure bump 12 on the rear part of the wheel 11 and the sheath body over the rear of the wheel 11. The said “above”, “under”, “front” and “rear” in the present invention means the relative direction and are directions of parts and components when the sharpening rod 4 as shown in FIG. 1 is drawn into the storage chute. In such a case, the sharpening rod is inside the storage chute, the locking slope 15 on the front lateral side of the locking block 14 closely leans on the compaction slope 10 on the rear part of the sharpening rod 4 to lock the sharpening rod inside the storage chute in an axial direction. When using the sharpening rod, the operator can operate the switch handle 6 forward to drive wheel 11 to make the pressure bump 12 rotate to the rear of the switch pin 7 (see FIG. 2 and FIG. 3). In this process, the locking pressure spring is pressed. After the pressure of locking lever 5 from the pressure bump disappears, under the action of the elasticity of the pop-up pressure spring 2, the sharpening rod slides backward, the locking lever 5 rotates under the action of the compaction slope 10 and the locking slope 15, the locking block separates from the rear part of the sharpening rod, and the sharpening rod pops up backward.

The present invention makes progress. Said storage chute inside is provided with a connection fixing sleeve which can only slide inside the said storage chute 16, the front end of the sharpening rod 4 is installed inside the connection fixing sleeve, and the rear part of the pop-up pressure spring 2 connects to the front end of the connection fixing sleeve 16 in a fixed way. The sharpening rod fits the clearance of the storage chute, the contact surface between the connection fixing sleeve and the storage chute is small, and the slide resistance is small, so slide can be smoother.

The present invention makes progress. The rear part of the said sheath body 1 in the present invention is provided with a sharpener 9, the rear part of the sheath body of the said sharpener 9 is provided with a V-shaped mounting slot, the mounting slot inside is installed with two pieces of knife stone provided in the shape of V, and the knife stone is a small ceramic rod. After the fish fillet knife is not used for a long time and is relatively blunt, the knife can be quickly sharpened with the sharpener roughly and then can be sharpened with the sharpening rod finely. The said sharpening rod is made of ceramic.

When using the present invention, the operator should draw the fish fillet knife out from the sheath, operate the switch handle forward and release the sharpening rod. Under the action of the pop-up pressure spring, the rear part of the sharpening rod pops up backward from the sheath body. The front part of the sharpening rod is inside the sheath body. By holding the sheath body with one hand and holding the fish fillet knife with the other hand, the fish fillet knife can be sharpened finely with the sharpening rod. After sharpening is finished, the operator should push the sharpening rod into the storage chute, and then the rear part of the locking lever lowers to the locking slope and contacts with the compaction slope; under the action of the locking pressure spring, the wheel runs, until the pressure bump is above the locking lever and the pressure plane closely leans on the upper side of the locking lever, to lock the sharpening rod in the axial direction. The present invention is characterized by a simple structure, convenient use and neat and beautiful appearance and is not easy to hurt hands.

What is claimed is:

1. A fish fillet knife sheath with the sharpening function and provided with a sheath body, characterized in that the sheath body inside is provided with a storage chute, the storage chute inside is provided with a sharpening rod which can slide in the axial direction, there is a pop-up pressure spring between the front end of the storage chute and the front end of the sharpening rod, the sheath body on the side of the storage chute in the rear of the sheath body is provided with a locking lever with a hinge, the rear part of the locking lever is provided with a locking block which extrudes towards the sharpening rod, the front lateral side of the locking block is provided with a locking slope oblique towards the sharpening rod from the front to the back; the rear part of the sharpening rod is provided with a compaction slope which is coordinated with the locking slope, the sheath body is provided with a cam switch via the switch pin with a hinge and the cam switch is provided with a locking pressure spring.

2. The said fish fillet knife sheath with the sharpening function in claim 1, characterized in that said storage chute is provided on the upper part of the sheath body, said locking lever is straight and is provided above the sharpening rod; the structure of the said cam switch is as follows: the sheath body above the locking lever is provided with a wheel under which there is a pressure bump, there is a pressure plane which can closely lean on the upper side of the locking lever on the lower lateral side of the pressure bump, there is a switch handle above the wheel, said locking pressure spring is provided between the rear part of the wheel or the pressure bump on the rear part of the wheel and the sheath body above the wheel or over the rear of the wheel.

3. The said fish fillet knife sheath with the sharpening function in claim 1, characterized in that said locking lever is a straight rod whose cross section is rectangular.

4. The said fish fillet knife sheath with the sharpening function in claim 1, characterized in that said storage chute inside is provided with a connection fixing sleeve which can slide inside the said storage chute, the front end of the sharpening rod is installed inside the connection fixing sleeve, and the rear part of the pop-up pressure spring connects to the front end of the connection fixing sleeve in a fixed way.

5. The said fish fillet knife sheath with the sharpening function in claim 1, characterized in that the rear part of the said sheath body is provided with a sharpener, the rear part of the sheath body is provided with a V-shaped mounting slot, and the mounting slot inside is installed with two pieces of knife stone provided in the shape of V.
